(19) United States
(12) Patent Application Publication
(10) Pub. No.: US 2026/0112715 A1
(43) Pub. Date: Apr. 23, 2026

(54) BATTERY MANAGEMENT APPARATUS AND BATTERY MANAGEMENT METHOD

(71) Applicant: TOYOTA JIDOSHA KABUSHIKI KAISHA, Toyota-shi (JP)

(72) Inventors: Yuji Nishi, Nagoya-shi (JP); Yoshiaki Kikuchi, Toyota-shi (JP); Ryo Mano, Nisshin-shi (JP); Hiroki Tashiro, Nisshin-shi (JP); Keisuke Ishikawa, Nagakute-shi (JP)

(73) Assignee: TOYOTA JIDOSHA KABUSHIKI KAISHA, Toyota-shi (JP)

(21) Appl. No.: 19/335,395

(22) Filed: Sep. 22, 2025

(30) Foreign Application Priority Data
Oct. 22, 2024 (JP) 2024-185683

(51) Int. Cl. H01M 10/42; H01M 10/0525

(52) U.S. Cl. CPC H01M 10/425; H01M 10/0525; H01M 2010/4271

(57) ABSTRACT

A battery management apparatus according to the present disclosure includes: an AC signal supply unit configured to supply an AC signal to a lithium-ion secondary battery; an impedance detection unit configured to detect a value of a real part of an AC impedance from the lithium-ion secondary battery to which the AC signal has been supplied; an expansion amount calculation unit configured to calculate an amount of expansion of a cell in the lithium-ion secondary battery based on a difference between the detected current value of the real part of the AC impedance and an initial value of the real part of the AC impedance; and a control unit configured to decrease an upper limit value of a state of charge of the lithium-ion secondary battery as the calculated amount of expansion increases.

### CROSS REFERENCE TO RELATED APPLICATIONS

This application is based upon and claims the benefit of priority from Japanese patent application No. 2024-185683, filed on Oct. 22, 2024, the disclosure of which is incorporated herein in its entirety by reference.

### BACKGROUND

The present disclosure relates to a battery management apparatus and a battery management method.

As disclosed in Patent Literature 1, the inventors have developed a method for detecting a real part of an AC impedance of a lithium-ion secondary battery using a high-frequency signal, and calculating the amount of Li precipitation in the lithium-ion secondary battery based on a difference between the current value of the real part of the AC impedance and its initial value.
[Patent Literature 1] Japanese Unexamined Patent Application Publication No. 2022-108602

### SUMMARY

It is known that when charging and discharging are repeated in a lithium-ion secondary battery, cells constituting a cell stack expand. For example, when a cell stack is restrained by a band or the like, if expansion of a cell progresses, a problem such as breaking of the band may occur, so that it is required to suppress the expansion of a cell.

However, a method for detecting expansion of a cell in a lithium-ion secondary battery in a nondestructive manner is not known.

The present disclosure has been made in view of the above-described circumstances, and provides a battery management apparatus capable of detecting expansion of a cell in a lithium-ion secondary battery in a nondestructive manner and suppressing the expansion of a cell.

A battery management apparatus according to the present disclosure includes:
an AC signal supply unit configured to supply an AC signal to a lithium-ion secondary battery;
an impedance detection unit configured to detect a value of a real part of an AC impedance from the lithium-ion secondary battery to which the AC signal has been supplied;
an expansion amount calculation unit configured to calculate an amount of expansion of a cell in the lithium-ion secondary battery based on a difference between the detected current value of the real part of the AC impedance and an initial value of the real part of the AC impedance; and
a control unit configured to decrease an upper limit value of a state of charge of the lithium-ion secondary battery as the calculated amount of expansion increases.

The battery management apparatus according to the present disclosure calculates an amount of expansion of a cell in a lithium-ion secondary battery based on a difference between the detected current value of a real part of an AC impedance and an initial value of the real part of the AC impedance, and decrease an upper limit value of a state of charge of the lithium-ion secondary battery as the calculated amount of expansion increases. By the above configuration, it is possible to detect expansion of a cell in a lithium-ion secondary battery in a nondestructive manner and suppress the expansion of a cell.

According to the present disclosure, it is possible to provide a battery management apparatus capable of detecting expansion of a cell in a lithium-ion secondary battery in a nondestructive manner and suppressing the expansion of a cell.

The above and other objects, features and advantages of the present disclosure will become more fully understood from the detailed description given hereinbelow and the accompanying drawings.

### BRIEF DESCRIPTION OF DRAWINGS

FIG. 1 is a block diagram showing an example of a configuration of a battery management system according to a first embodiment;

FIG. 2 is a flowchart showing a battery management method according to the first embodiment;

FIG. 3 is a graph showing control patterns of an upper limit value of an SOC with respect to an amount of expansion by a control unit 14;

FIG. 4 is a block diagram showing an example of aa configuration of a battery management system according to a second embodiment;

FIG. 5 is a graph showing a relationship between an SOH of a secondary battery 20 and an amount of change (a difference between the detected value and the initial value) of a real part Z of an AC impedance when a second AC signal of 1 MHz is supplied to the secondary battery 20;

FIG. 6 is a graph showing a relationship between a frequency of an AC signal supplied to the secondary battery and the real part of the AC impedance detected from the secondary battery; and

FIG. 7 is a graph showing a relationship between a frequency of an AC signal supplied to the secondary battery and the real part of the AC impedance detected from the secondary battery.

### DESCRIPTION OF EMBODIMENTS

Specific embodiments to which the present disclosure is applied will be described hereinafter in detail with reference to the drawings. However, the present disclosure is not limited to the following embodiments. Further, for the clarification of the description, the following descriptions and the drawings are simplified as appropriate.

### First Embodiment

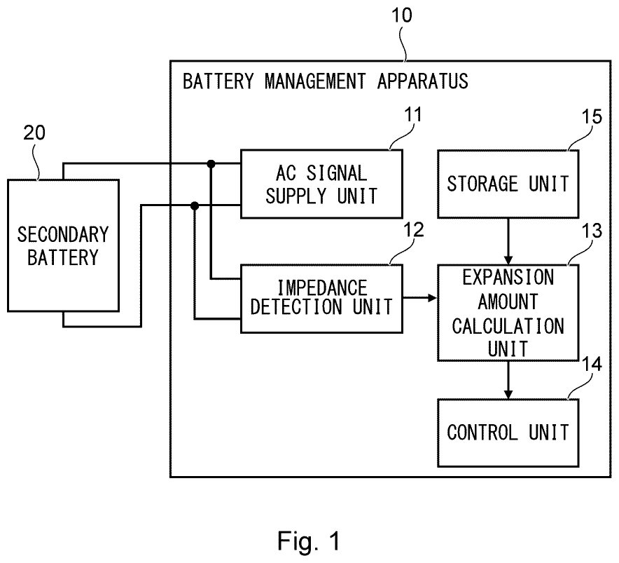

FIG. 1 is a block diagram showing an example of a configuration of a battery management system according to a first embodiment. As shown in FIG. 1, a battery management system includes a battery management apparatus 10 and a secondary battery 20 managed by the battery management apparatus 10.

### <Configuration of the Secondary Battery 20>

First, the secondary battery 20 to be managed will be described.

The secondary battery 20 is a lithium-ion secondary battery, and includes a cell stack composed of a plurality of stacked battery cells and a case for accommodating the cell stack. Each of the battery cells includes a positive electrode, a negative electrode, and an ion transmission medium which is provided between the positive electrode and the negative electrode and conducts carrier ions. A separator may be further provided between the positive electrode and the negative electrode. A resin such as polyethylene or polypropylene is used as the separator.

For example, a sulfide containing a transition metal element, an oxide containing lithium and a transition metal element, or the like is used as a positive electrode active material. Specifically, a lithium manganese composite oxide in which a basic composition formula is, for example, Li₍₁₋ₓ₎MnO₂ (where 0<x<1), Li₍₁₋ₓ₎Mn₂O₄, a lithium cobalt composite oxide in which a basic composition formula is, for example, Li₍₁₋ₓ₎CoO₂, a lithium nickel composite oxide in which a basic composition formula is, for example, Li₍₁₋ₓ₎NiO₂, a lithium nickel cobalt manganese composite oxide in which a basic composition formula is, for example, Li₍ᵢ₋ₓ₎NiₐCo_{b}Mn_{c}O₂ (where a+b+c=1), or the like is used as a positive electrode active material. Note that a material in which other elements are contained in the above-mentioned basic composition formula may be used as a positive electrode active material. For example, Al (aluminum) is used as a current collector of a positive electrode.

For example, a composite oxide containing lithium, a carbon material, or the like is used as a negative electrode active material. Specifically, an inorganic compound such as lithium, a lithium alloy, and a tin compound, a carbon material capable of occluding and releasing lithium ions, a composite oxide containing a plurality of elements, a conductive polymer, or the like is used as a negative electrode active material. Examples of the carbon material used as a negative electrode active material include cokes, glassy carbons, graphites, non-graphitizable carbons, pyrolytic carbons, and a carbon fiber, and it is preferred that graphites such as artificial graphite or natural graphite be used. Further, examples of the composite oxide used as a negative electrode active material include a lithium titanium composite oxide and a lithium vanadium composite oxide. For example, Cu (copper) is used as a current collector of a negative electrode.

An ion-conducting medium is used as an electrolyte, for example, by dissolving a supporting salt. For example, a lithium salt such as LiPF₆ and LiBF₄ is used as a supporting salt. For example, one of carbonates, esters, ethers, nitriles, furans, sulfolanes, and dioxolanes or a mixture of some of them is used as a solvent of an electrolyte. Examples of the carbonates include cyclic carbonates such as ethylene carbonate, propylene carbonate, vinylene carbonate, butylene carbonate, and chloroethylene carbonate, and chain carbonates such as dimethyl carbonate, ethyl methyl carbonate, diethyl carbonate, ethyl-n-butyl carbonate, methyl-t-butyl carbonate, di-i-propyl carbonate, and t-butyl-i-propyl carbonate. Alternatively, a solid ion-conducting polymer, an inorganic solid electrolyte, a mixed material of an organic polymer electrolyte and an inorganic solid electrolyte, an inorganic solid powder bonded by an organic binder, or the like may be used as the ion-conducting medium.

### <Configuration of the Battery Management Apparatus 10>

Next, the battery management apparatus 10 that manages the secondary battery 20 will be described.

As shown in FIG. 1, the battery management apparatus 10 includes an AC signal supply unit 11, an impedance detection unit 12, an expansion amount calculation unit 13, a control unit 14, and a storage unit 15, and manages the charging of the secondary battery 20 to be managed. The battery management apparatus 10 calculates the amount of expansion in the secondary battery 20, and feedback-controls an upper limit value of a State of Charge (SOC) for the secondary battery 20 based on a result of the calculation.

Note that the battery management apparatus 10 includes, as hardware, an arithmetic unit such as a Central Processing Unit (CPU), which is not shown, in addition to a storage unit 15 such as a Random Access Memory (RAM) and a Read Only Memory (ROM), which store various types of programs, data, etc. That is, the battery management apparatus 10 functions as a computer, and performs various types of processing based on the above-mentioned various types programs etc.

Therefore, the functional blocks of the AC signal supply unit 11, the impedance detection unit 12, the expansion amount calculation unit 13, and the control unit 14 constituting the battery management apparatus 10 in FIG. 1 may be configured as regards hardware by a Central Processing Unit (CPU), a memory, and other circuits, and may be implemented as regards software by a program loaded into the memory. That is, the above functional blocks can be implemented in various forms by computer hardware, computer software, or a combination thereof.

The AC signal supply unit 11 supplies an AC signal (a first AC signal) for detecting the amount of expansion to the secondary battery 20. For example, the AC signal supply unit 11 supplies an AC signal having a frequency of 500 to 1500 Hz to the secondary battery 20. The frequency of the AC signal is preferably 700 to 1000 Hz.

The impedance detection unit 12 detects a value of a real part Z of an AC impedance from the secondary battery 20 to which the first AC signal is supplied. As the amount of expansion increases, the electrode interval in each of the battery cells increases and the electrolyte resistance increases, and thus the value of the real part Z of the AC impedance detected by the impedance detection unit 12 increases.

The expansion amount calculation unit 13 calculates the amount of expansion in the secondary battery 20 from the value of the real part Z of the AC impedance detected by the impedance detection unit 12 when the first AC signal is supplied to the secondary battery 20. More specifically, the expansion amount calculation unit 13 calculates the amount of expansion in the secondary battery 20 based on a difference between the current value of the real part Z of the AC impedance detected by the impedance detection unit 12 when the first AC signal is supplied to the secondary battery 20 and its initial value.

The expansion amount calculation unit 13 calculates a smaller amount of expansion as the detected value of the real part Z of the AC impedance becomes smaller and the difference between the current value and the initial value becomes smaller. On the other hand, the expansion amount calculation unit 13 calculates a larger amount of expansion as the detected value of the real part Z of the AC impedance becomes larger and the difference between the current value and the initial value becomes larger.

Note that the initial value of the real part Z of the AC impedance when the first AC signal is supplied to the secondary battery 20 to be managed is stored, for example, in the storage unit 15. Further, map information representing a relationship between a difference (an amount of change) between the current value (the detected value) of the real part Z of the AC impedance when the first AC signal is supplied to the secondary battery of each type and its initial value and the amount of expansion may be stored in the storage unit 15.

This map information is, for example, information obtained in advance by an experiment or the like, and may be updated as appropriate based on information detected when the first AC signal is supplied to the secondary battery 20 to be managed. When the map information is used, the expansion amount calculation unit 13 extracts the amount of expansion corresponding to the value of the real part Z of the AC impedance detected by the impedance detection unit 12 when the first AC signal is supplied to the secondary battery 20 from the map information stored in the storage unit 15.

The control unit 14 controls the upper limit value of the SOC for the secondary battery 20 based on the amount of expansion calculated by the expansion amount calculation unit 13. Specifically, the control unit 14 controls the upper limit value of the SOC in such a manner that it decreases as the amount of expansion calculated by the expansion amount calculation unit 13 increases, because it is necessary to suppress the progress of expansion.

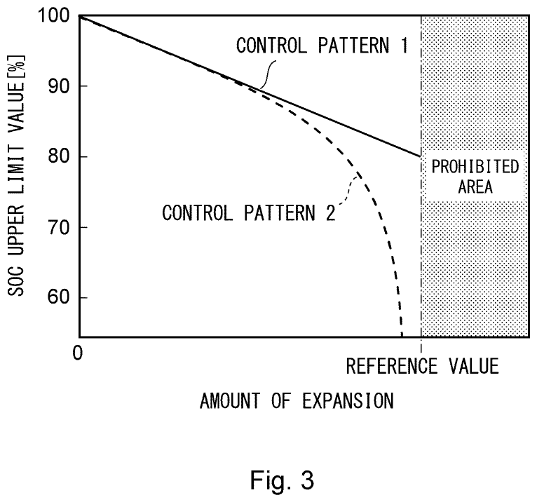

For example, the control unit 14 controls the upper limit value of the SOC in such a manner that as the amount of expansion calculated by the expansion amount calculation unit 13 increases, the upper limit value of the SOC gradually decreases to, for example, 95% and then 90% when the initial upper limit value of the SOC is set to 100%. The details of the control of the upper limit value of the SOC by the control unit 14 will be described later with reference to FIG. 3.

As described above, the battery management apparatus 10 according to this embodiment calculates the amount of expansion in the secondary battery 20 from the value of the real part Z of the AC impedance detected when the first AC signal is supplied to the secondary battery 20, and decreases the upper limit value of the SOC as the calculated amount of expansion increases. Therefore, the expansion of a cell of the secondary battery 20 can be suppressed.

That is, in the battery management apparatus 10 according to this embodiment, it is possible to, by detecting expansion of a cell in the secondary battery 20 in a nondestructive manner and decreasing the upper limit value of the SOC as the amount of expansion increases, suppress the expansion of a cell.

### <Battery Management Method>

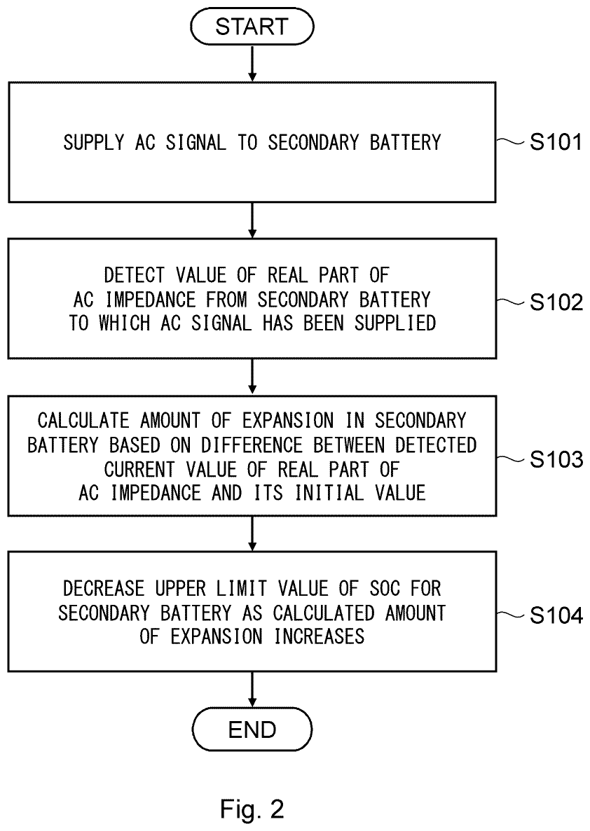

Next, a battery management method, that is, operations performed by the battery management apparatus 10 according to this embodiment will be described with reference to FIG. 2. FIG. 2 is a flowchart showing the battery management method according to the first embodiment.

First, the AC signal supply unit 11 supplies an AC signal (the first AC signal) for detecting the amount of expansion to the secondary battery 20 (Step S101).

Next, the impedance detection unit 12 detects a value of the real part Z of the AC impedance from the secondary battery 20 to which the first AC signal has been supplied (Step S102).

Next, the expansion amount calculation unit 13 calculates the amount of expansion in the secondary battery 20 based on the difference between the detected value, i.e., the current value, of the real part Z of the AC impedance and its initial value (Step S103).

For example, the expansion amount calculation unit 13 extracts the amount of expansion corresponding to the difference between the detected current value of the real part Z of the AC impedance and its initial value from map information stored in the storage unit 15. Specifically, the expansion amount calculation unit 13 calculates a smaller amount of expansion as the difference between the detected current value of the real part Z of the AC impedance and its initial value becomes smaller, while it calculates a larger amount of expansion as the difference between the detected current value of the real part Z of the AC impedance and its initial value becomes larger.

Lastly, the control unit 14 controls the upper limit value of the SOC for the secondary battery 20 based on the amount of expansion calculated by the expansion amount calculation unit 13. Specifically, the control unit 14 controls the upper limit value of the SOC in such a manner that it decreases as the amount of expansion calculated by the expansion amount calculation unit 13 increases, because it is necessary to suppress the progress of expansion (Step S104).

FIG. 3 is a graph showing control patterns of the upper limit value of the SOC with respect to the amount of expansion by the control unit 14. In FIG. 3, the horizontal axis indicates the amount of expansion, and the vertical axis indicates the upper limit value (%) of the SOC. A “prohibited area” shown in FIG. 3 means that when the amount of expansion exceeds a predetermined reference value, the use of the secondary battery 20 is prohibited.

As shown in FIG. 3, in both of control patterns 1 and 2, the upper limit value of the SOC is decreased as the amount of expansion increases.

As shown by a solid line in FIG. 3, in the control pattern 1, the control unit 14 linearly decreases the upper limit value of the SOC with respect to the calculated amount of expansion. Then, when the amount of expansion reaches a predetermined reference value, the control unit 14 outputs an alarm indicating that the use of the secondary battery 20 is prohibited.

On the other hand, as shown by a broken line in FIG. 3, in the control pattern 2, the control unit 14 increases the range of the decrease of the upper limit value of the SOC with respect to the increase of the amount of expansion as the amount of expansion approaches a reference value, in order to prevent the calculated amount of expansion from reaching the reference value.

Note that the control pattern of the upper limit value of the SOC relative to the amount of expansion by the control unit 14 is not limited to the control patterns 1 and 2 shown in FIG. 3. That is, the control unit 14 may decrease the upper limit value of the SOC as the amount of expansion increases in various forms.

As described above, in the battery management method according to this embodiment, the amount of expansion in the secondary battery 20 is calculated from the value of the real part Z of the AC impedance detected when the first AC signal is supplied to the secondary battery 20, and the upper limit value of the SOC is decreased as the calculated amount of expansion increases. Therefore, the expansion of a cell of the secondary battery 20 can be suppressed.

That is, in the battery management method according to this embodiment, it is possible to, by detecting expansion of a cell in the secondary battery 20 in a nondestructive manner and decreasing the upper limit value of the SOC as the amount of expansion increases, suppress the expansion of a cell.

### Second Embodiment

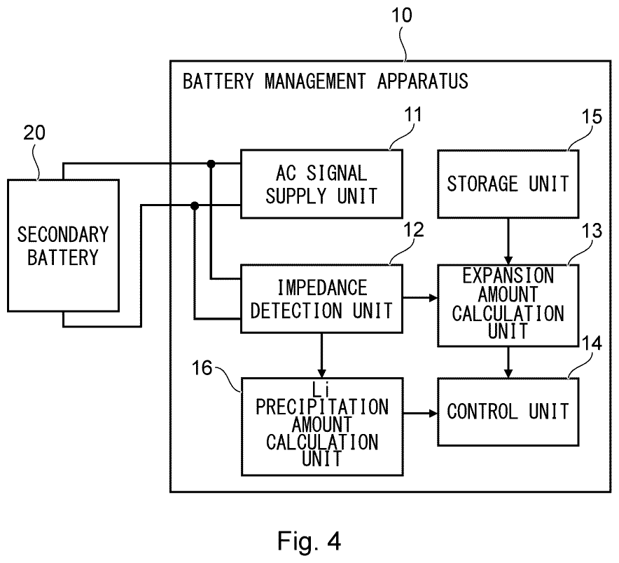

Next, the battery management apparatus 10 according to a second embodiment will be described with reference to FIG. 4. FIG. 4 is a block diagram showing an example of a configuration of a battery management system according to the second embodiment. As shown in FIG. 4, the battery management apparatus 10 according to this embodiment includes an Li precipitation amount calculation unit 16 in addition to the AC signal supply unit 11, the impedance detection unit 12, the expansion amount calculation unit 13, the control unit 14, and the storage unit 15 shown in FIG. 1.

In the secondary battery 20, metal Li is precipitated in the electrode surface of each of the battery cells by repeatedly charging the secondary battery 20. The Li precipitation progresses as the charging power is increased in order to increase the charging speed, and hence a state of health (SOH) of the secondary battery 20 deteriorates.

Note that the SOH of the secondary battery 20 is a percentage of the current full charge capacity when it is assumed that the initial full charge capacity of the secondary battery 20 is 100%. Therefore, it is desirable to set for the secondary battery 20 the highest possible allowable charging power Pa which enables the secondary battery 20 to be efficiently charged in the shortest possible charging time while suppressing Li precipitation.

In this embodiment, in addition to the first AC signal for detecting the amount of expansion, the AC signal supply unit 11 supplies a second AC signal having a frequency of 0.1 MHz or higher for detecting the amount of Li precipitation to the secondary battery 20. The second AC signal is preferably a high-frequency signal of a frequency with which a value of the real part Z of the AC impedance that is 10 times or greater than a value of the real part Z of the AC impedance detected when the first AC signal is supplied to the lithium-ion secondary battery 20 can be detected due to skin effect. Specifically, the frequency of the second AC signal is preferably 0.5 MHz or higher.

When the second AC signal having the above frequency is supplied to the secondary battery 20, the diffusion, reaction, and movement of lithium ions cannot be followed in each of the battery cells of the secondary battery 20. Therefore, the displacement current of the second AC signal flows through an electrode surface of each of the battery cells where Li precipitation easily occurs due to skin effect.

As the amount of Li precipitation decreases, the electric conductivity of the electrode surface of each of the battery cells decreases, and thus the value of the real part Z of the AC impedance increases. On the other hand, as the amount of Li precipitation increases, the electric conductivity of the electrode surface of each of the battery cells increases, and thus the value of the real part Z of the AC impedance decreases.

Therefore, the amount of Li precipitation of the secondary battery 20 can be calculated from the amount of change (the difference between the detected value and the initial value) of the real part Z of the AC impedance detected from the secondary battery 20 to which the second AC signal has been supplied. Further, the SOH of the secondary battery 20 can be estimated based on the amount of Li precipitation.

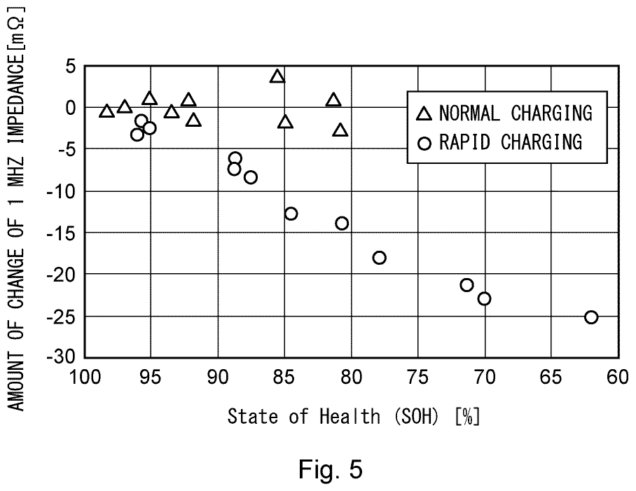

FIG. 5 is a graph showing a relationship between the SOH of the secondary battery 20 and the amount of change (the difference between the detected value and the initial value) of the real part Z of the AC impedance when the second AC signal of 1 MHz is supplied to the secondary battery 20.

As indicated by triangles in FIG. 5, in the case of a normal charging where the charging power is low, the amount of Li precipitation is low even if charging is repeated. Thus, the amount of change of the real part Z of the AC impedance remains small even if the degradation of the SOH progresses due to other factors. That is, the detected value of the real part Z of the AC impedance is maintained high.

On the other hand, as indicated by circles in FIG. 5, in the case of a rapid charging where the charging power is high, the amount of amount of Li precipitation increases when charging is repeated. As a result, the degradation of the SOH progresses, and thus the amount of change of the real part Z of the AC impedance increases. That is, the detected value of the real part Z of the AC impedance is low.

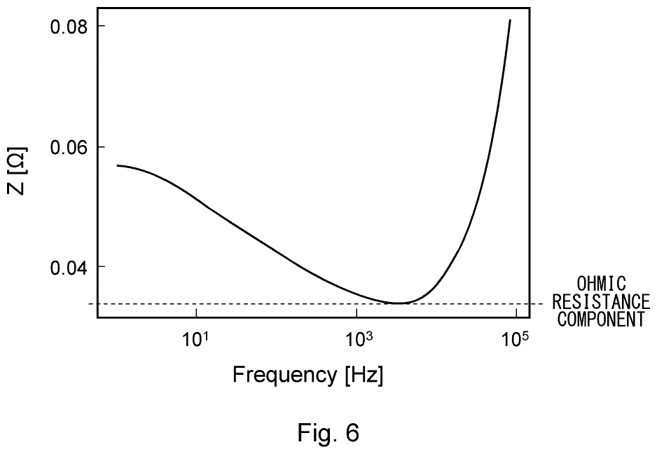

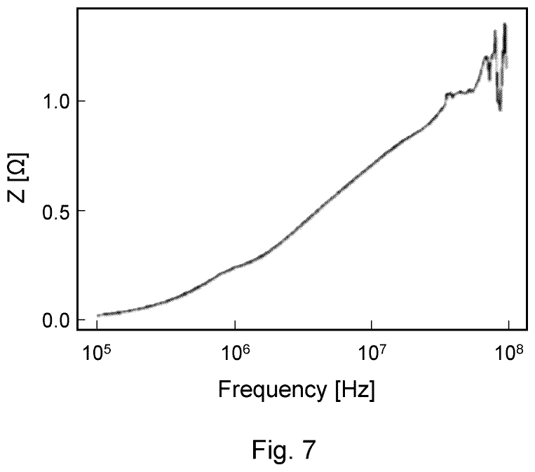

Each of FIGS. 6 and 7 is a graph showing a relationship between a frequency of an AC signal supplied to the secondary battery 20 and the real part of the AC impedance detected from the secondary battery 20. FIG. 6 shows the values of the real part Z of the AC impedance when AC signals of 1 kHz to 100 kHz are supplied to the secondary battery 20. FIG. 7 shows the values of the real part Z of the AC impedance when AC signals of 100 kHz to 100 MHz are supplied to the secondary battery 20.

As shown in FIG. 6, when the AC signal of about 1 kHz, which is roughly the same frequency as that of the first AC signal for detecting the amount of expansion, is supplied to the secondary battery 20, the value of the real part Z of the AC impedance is the minimum value. This impedance component indicates an ohmic resistance component. Further, as shown in FIGS. 6 and 7, the higher the frequency of the AC signal supplied to the secondary battery 20, the more the current flow is concentrated in the electrode surface of each of the cells due to skin effect, and thus the value of the real part Z of the AC impedance increases.

Therefore, the AC signal supply unit 11 supplies, to the secondary battery 20, the second AC signal of a high frequency with which a value of the real part Z of the AC impedance sufficiently higher than the ohmic resistance component can be detected.

The impedance detection unit 12 detects a value of the real part Z of the AC impedance from the secondary battery 20 to which the first AC signal has been supplied, and detects a value of the real part Z of the AC impedance from the secondary battery 20 to which the second AC signal has been supplied. As described above, the displacement current of the second AC signal supplied from the AC signal supply unit 11 to the secondary battery 20 flows through the electrode surface (an Li precipitation region) of each of the battery cells of the secondary battery 20 due to skin effect. Therefore, the impedance detection unit 12 can detect the real part Z of the AC impedance corresponding to the amount of Li precipitation.

The Li precipitation amount calculation unit 16 calculates the amount of Li precipitation in the secondary battery 20 based on the difference between the current value of the real part Z of the AC impedance detected by the impedance detection unit 12 when the second AC signal is supplied to the secondary battery 20 and its initial value. More specifically, the Li precipitation amount calculation unit 16 calculates a smaller amount of Li precipitation as the detected value of the real part Z of the AC impedance becomes larger and the difference between the detected value and the initial value becomes smaller. On the other hand, the Li precipitation amount calculation unit 16 calculates a larger amount of Li precipitation as the detected value of the real part Z of the AC impedance becomes smaller and the difference between the detected value and the initial value becomes larger.

Note that the initial value of the real part Z of the AC impedance when the second AC signal is supplied to the secondary battery 20 to be managed is stored, for example, in the storage unit 15. Further, map information representing a relationship between the difference (the amount of change) between the current value (the detected value) of the real part Z of the AC impedance when the second AC signal is supplied to the secondary battery of each type and its initial value and the amount of Li precipitation may be stored in the storage unit 15.

This map information is, for example, information obtained in advance by an experiment or the like, and may be updated as appropriate based on information detected when the second AC signal is supplied to the secondary battery 20 to be managed. When the map information is used, the Li precipitation amount calculation unit 16 extracts the amount of Li precipitation corresponding to the value of the real part Z of the AC impedance detected by the impedance detection unit 12 when the second AC signal is supplied to the secondary battery 20 from the map information stored in the storage unit 15.

The control unit 14 controls the allowable charging power Pa for the secondary battery 20 based on amount of Li precipitation calculated by the Li precipitation amount calculation unit 16. Specifically, the control unit 14 controls the allowable charging power Pa in such a manner that it decreases as the amount of Li precipitation calculated by the Li precipitation amount calculation unit 16 increases, because it is necessary to suppress the progress of Li precipitation.

For example, the control unit 14 controls the allowable charging power Pa in such a manner that as amount of Li precipitation calculated by the Li precipitation amount calculation unit 16 increases, the allowable charging power Pa gradually decreases to, for example, 95% and then 90% when an initial allowable charging power Pa0 is set to 100%.

Note that the initial allowable charging power Pa0, which is the allowable charging power of the new secondary battery 20, is determined in advance for each type of the secondary battery 20, and stored, for example, in the storage unit 15.

Configurations other than the above ones are similar to those of the first embodiment, and the detailed descriptions thereof will thus be omitted.

Like in the case of the first embodiment, the battery management apparatus 10 according to this embodiment calculates the amount of expansion in the secondary battery 20 from the value of the real part Z of the AC impedance detected when the first AC signal is supplied to the secondary battery 20, and decreases the upper limit value of the SOC as the calculated amount of expansion increases. Therefore, the expansion of a cell of the secondary battery 20 can be suppressed.

That is, in the battery management apparatus 10 according to this embodiment, it is possible to, by detecting expansion of a cell in the secondary battery 20 in a nondestructive manner and decreasing the upper limit value of the SOC as the amount of expansion increases, suppress the expansion of a cell.

Further, the battery management apparatus 10 according to this embodiment calculates the amount of Li precipitation in the secondary battery 20 from the value of the real part Z of the AC impedance detected when the second AC signal is supplied to the secondary battery 20. Then, the battery management apparatus 10 decreases the allowable charging power Pa so as to suppress the progress of Li precipitation, as the calculated amount of Li precipitation increases. Therefore, the allowable charging power at the start of use of the secondary battery 20, i.e., the initial allowable charging power Pa0, can be set to a high level at which Li precipitation does not progress in products included in the range of, for example, ±3σ instead of the conventional range of ±6σ, and charging time can be shortened. That is, the battery management apparatus 10 according to this embodiment can set the allowable charging power Pa to an appropriate value in accordance with the amount of Li precipitation without setting the initial allowable charging power Pa0 for the secondary battery 20 to an excessively low value, and therefore it is possible to efficiently charge the secondary battery 20.

### Third Embodiment

Next, the battery management apparatus 10 according to a third embodiment will be described.

Note that the battery management apparatus 10 according to the third embodiment is similar to the battery management apparatus 10 according to the second embodiment shown in FIG. 4.

In the second embodiment, the real part of the AC impedance detected when the second AC signal for detecting the amount of Li precipitation is supplied decreases as the Li precipitation progresses, but increases due to expansion. Therefore, when expansion has occurred, the Li precipitation amount calculation unit 16 cannot accurately calculate the amount of Li precipitation from a difference (a second amount of change ΔR2) between the current value of the real part of the AC impedance detected when the second AC signal is supplied and its initial value.

Therefore, in the battery management apparatus 10 according to a modified example of the second embodiment, the Li precipitation amount calculation unit 16 acquires the real part of the AC impedance detected when the first AC signal is supplied in addition to the real part of the AC impedance detected when the second AC signal is supplied. Then the Li precipitation amount calculation unit 16 corrects the second amount of change ΔR2 using a difference (a first amount of change ΔR1) between the current value of the real part of the AC impedance detected when the first AC signal is supplied and its initial value.

The correction of the second amount of change ΔR2 will be described below.

The second amount of change ΔR2 is the sum of an amount of change ΔR2s due to expansion and an amount of change ΔR2p due to Li precipitation, and the following equation (1) holds.

$$Δ R 2 = Δ R 2 s + Δ R 2 p \qquad ( 1 )$$

On the other hand, the real part of the AC impedance detected when the first AC signal is supplied increases due to expansion, but does not change due to Li precipitation. That is, the first amount of change ΔR1 is generated only due to expansion and is not generated due to Li precipitation.

Note that the first amount of change ΔR1 and the amount of change ΔR2s due to expansion in the equation (1) have a one-to-one correspondence relation since each of them is the amount of change of the real part of the AC impedance generated by expansion. Therefore, the amount of change ΔR2s due to expansion in the equation (1) can be expressed by the following equation (2) as a function F (ΔR1) of the first amount of change ΔR1.

$$Δ R 2 s = F ( Δ R 1 ) \qquad ( 2 )$$

The correspondence relation of the above equation (2) is acquired in advance by an experiment or the like, and for example, stored in the storage unit 15 as map information.

By substituting the equation (2) into the equation (1) and transposing it, the following equation (3) regarding the amount of change ΔR2p due to Li precipitation in equation (1) can be obtained.

$$Δ R 2 p = Δ R 2 - F ( Δ R 1 ) \qquad ( 3 )$$

As shown in the equation (3), in the battery management apparatus 10 according to this embodiment, the second amount of change ΔR2 is corrected using the first amount of change ΔR1. Then the amount of Li precipitation is calculated using the net amount of change ΔR2p due to Li precipitation obtained by the correction. Therefore, the battery management apparatus 10 according to this embodiment can calculate an amount of Li precipitation more accurately than the battery management apparatus 10 according to the second embodiment does, which uses the second amount of change ΔR2 as it is without correcting it.

Configurations other than the above ones are similar to those of the second embodiment, and the detailed descriptions thereof will thus be omitted.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A battery management apparatus comprising:
an AC signal supply unit configured to supply an AC signal to a lithium-ion secondary battery;
an impedance detection unit configured to detect a value of a real part of an AC impedance from the lithium-ion secondary battery to which the AC signal has been supplied;
an expansion amount calculation unit configured to calculate an amount of expansion of a cell in the lithium-ion secondary battery based on a difference between the detected current value of the real part of the AC impedance and an initial value of the real part of the AC impedance; and
a control unit configured to decrease an upper limit value of a state of charge of the lithium-ion secondary battery as the calculated amount of expansion increases.

2. The battery management apparatus according to claim 1, wherein
the AC signal supply unit supplies a first AC signal having a frequency of 500 to 1500 Hz and a second AC signal having a frequency of 0.1 MHz or higher to the lithium-ion secondary battery,
the expansion amount calculation unit calculates the amount of expansion based on a first amount of change which is a difference between a current value of the real part of the AC impedance detected by the first AC signal and an initial value of the real part of the AC impedance,
the battery management apparatus further comprises an Li precipitation amount calculation unit configured to calculate am amount of Li precipitation in the lithium-ion secondary battery based on a second amount of change which is a difference between a current value of the real part of the AC impedance detected by the second AC signal and an initial value of the real part of the AC impedance, and
the control unit decreases an allowable charging power for the lithium-ion secondary battery as the calculated amount of Li precipitation increases.

3. The battery management apparatus according to claim 2, wherein the Li precipitation amount calculation unit corrects the second amount of change using the first amount of change and then calculates the amount of Li precipitation.

4. A battery management method comprising:
supplying an AC signal to a lithium-ion secondary battery;
detecting a value of a real part of an AC impedance from the lithium-ion secondary battery to which the AC signal has been supplied;
calculating an amount of expansion of a cell in the lithium-ion secondary battery based on a difference between the detected current value of the real part of the AC impedance and an initial value of the real part of the AC impedance; and
decreasing an upper limit value of a state of charge of the lithium-ion secondary battery as the calculated amount of expansion of the cell increases.
